(19) United States
(12) Patent Application Publication
(10) Pub. No.: US 2025/0091609 A1
(43) Pub. Date: Mar. 20, 2025

(54) ADVANCED DRIVING ASSISTANCE SYSTEM CONSTRAINT BASED ROUTING

(71) Applicant: QUALCOMM Incorporated, San Diego, CA (US)

(72) Inventors: Shabin MAHADEVAN, Lake Orion, MI (US); Nicholas Frank JOO, Rochester Hills, MI (US)

(21) Appl. No.: 18/466,899

(22) Filed: Sep. 14, 2023

(51) Int. Cl. B60W 60/00; B60W 30/12; B60W 30/18; B60W 50/14

(52) U.S. Cl. CPC B60W 60/0015; B60W 50/14; B60W 30/12; B60W 30/18163; B60W 2540/223; B60W 2540/225; B60W 2552/00; B60W 2556/40; B60W 2556/45

(57) ABSTRACT

Techniques for providing and utilizing supplemental information obtained from Vehicle-to-Everything (V2X) enabled entities to enhance navigation and routing based on opportunities to implement Advanced Driver Assistance Systems (ADAS) functions are discussed. An example method for generating routing information for a vehicle includes determining a desired destination, obtaining operational design domain information based at least in part on a geographic area including a present location and the desired destination, determining collaboration information for one or more driving assistance functions based on the operational design domain information, the collaboration information including indications of physical actions performed by vehicle operators when the one or more driving assistance functions are activated, and generating routing information based at least in part on the collaboration information.

### BACKGROUND

The following relates generally to autonomous driving and advanced driver assistance systems (ADAS). More specifically, embodiments of the disclosure are related to the use of supplemental information obtained from Vehicle-to-Everything (V2X) enabled entities to enhance navigation and routing based on opportunities to implement ADAS functions.

Advanced driver assistance systems (ADAS) are systems configured to automate/adapt/enhance vehicle systems for safety and better driving. For instance, ADAS can be used to avoid collisions and accidents by alerting the driver to potential problems, or by implementing safeguards and taking over control of the vehicle. Other common features associated with ADAS include automated lighting, automated braking, global positioning system (GPS)/traffic warnings, alerting the driver to other cars or dangers, displaying what is in blind spots, and keeping the driver in the correct lane. More complex ADAS features may include electronic stability control, anti-lock brakes, lane departure warning, adaptive cruise control and traction control, and even autonomous driving functionality.

ADAS relies on input and information from multiple data sources to be effective. ADAS can obtain some of the information directly from the primary vehicle through the use of sensors, automotive imaging, LiDAR, radar, image processing, computer vision, and so forth. Additional inputs are also possible from other sources separate from the primary vehicle platform, such as other vehicles and entities on the road. This kind of supplemental information is typically obtained through communication standards such as Vehicle-to-Vehicle (V2V), Vehicle-to-Infrastructure (V2I), and Vehicle-to-Everything (V2X) communication, which involves passing information between a vehicle and any other entity that may affect or be affected by the vehicle, such as infrastructure (e.g., a stop light), pedestrians, other vehicles, and so forth.

Supplemental information received from V2X-capable entities may have additional uses beyond directly driving on-board ADAS functionality. In particular, the supplemental information may be used to generate suggestions to improve vehicle performance and enhance the driving experience for the vehicle operator.

### SUMMARY

An example method for generating routing information for a vehicle configured with an advanced driver assistance system according to the disclosure includes obtaining a desired destination, obtaining operational design domain information based at least in part on a geographic area comprising a present location and the desired destination, and generating routing information based at least in part on collaboration information for one or more driving assistance functions associated with the operational design domain information, the collaboration information comprising indications of physical actions performed by vehicle operators when the one or more driving assistance functions are activated.

An example method for providing a collaboration score associated with an advanced driver assistance system to a vehicle according to the disclosure includes receiving location information and collaboration information from the vehicle, wherein the vehicle is configured to utilize the advanced driver assistance system, generating the collaboration score for at least one function of the advanced driver assistance system based on the collaboration information, the collaboration score being based on at least one indication in the collaboration information of a physical action performed by an operator of the vehicle when the at least one function of the advanced driver assistance system is activated, and providing the collaboration score to the vehicle.

An example method for providing routing information to a vehicle according to the disclosure includes receiving collaboration information from the vehicle, such that the vehicle is configured to utilize an advanced driver assistance system and the collaboration information comprises indications of a physical action performed by an operator of the vehicle when at least one function of the advanced driver assistance system is activated, generating routing information based at least in part on the collaboration information, and providing the routing information to the vehicle.

An example apparatus according to the disclosure includes at least one memory, at least one transceiver, at least one processor communicatively coupled to the at least one memory and the at least one transceiver, and configured to: obtain a desired destination, obtain operational design domain information based at least in part on a geographic area comprising a present location and the desired destination, and generate routing information based at least in part on collaboration information for one or more driving assistance functions associated with the operational design domain information, the collaboration information comprising indications of physical actions performed by vehicle operators when the one or more driving assistance functions are activated.

An example apparatus according to the disclosure includes at least one memory, at least one transceiver, at least one processor communicatively coupled to the at least one memory and the at least one transceiver, and configured to: receive location information and collaboration information from a vehicle configured to utilize an advanced driver assistance system, generate a collaboration score for at least one function of the advanced driver assistance system based on the collaboration information, the collaboration score being based on at least one indication in the collaboration information of a physical action performed by an operator of the vehicle when the at least one function of the advanced driver assistance system is activated, and provide the collaboration score to the vehicle.

An example apparatus according to the disclosure includes at least one memory, at least one transceiver, at least one processor communicatively coupled to the at least one memory and the at least one transceiver, and configured to: receive collaboration information from the vehicle, wherein the vehicle is configured to utilize an advanced driver assistance system and the collaboration information comprises indications of a physical action performed by an operator of the vehicle when at least one function of the advanced driver assistance system is activated, generate routing information based at least in part on the collaboration information, and provide the routing information to the vehicle.

Items and/or techniques described herein may provide one or more of the following capabilities, as well as other capabilities not mentioned. An ADAS equipped vehicle may be configured to utilize a navigation system. For example, a mobile device or user equipment may be operationally coupled to the vehicle. The navigation system may include a route planning application and configured to receive map data from a network. The map data may include operational design domain (ODD) information associated with locations along a route. The ODDs may be associated with ADAS functions and historical collaboration information. The collaboration information indicates the level of interaction between an operator and a vehicle and may be associated with ODDs and ADAS functions. A route planning application may be configured to utilize the ODD and collaboration information to generate ADAS friendly routes. The ADAS friendly routes may increase the opportunities for an operator to utilize ADAS functions. Routes with relatively lower collaboration scores may be reduced. Vehicle safety and operator effectiveness may be increased. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server.

FIG. 5 is a system diagram illustrating various example entities configured to utilize V2X communication links.

FIG. 6 is a block diagram of an example mobile device which is capable of providing ADAS constraint based routing.

FIG. 7A is a block diagram of a method for utilizing ADAS functions.

FIG. 7B is a block diagram of an example method for ADAS constraint based routing.

FIG. 8 includes lists of example ADAS functions for driving and safety use cases.

FIG. 9 is an example user interface of a street-level navigation map illustrating a routing application and examples of different operational design domains (ODDs) along a route.

FIG. 10 is a portion of the street-level navigation map of FIG. 9 indicating routing options utilizing supplemental ADAS constraint information.

FIG. 11 is an example process flow diagram for obtaining ADAS collaboration information for use in ADAS routing.

FIG. 12 is a process flow of an example method for generating route information for a vehicle configured with an advanced driver assistance system.

FIG. 13 is a process flow of an example method for providing a collaboration score associated with an ADAS to a vehicle.

FIG. 14 is a process flow of an example method for providing routing information to a vehicle.

### DETAILED DESCRIPTION

Techniques are discussed herein for providing and utilizing supplemental information obtained from Vehicle-to-Everything (V2X) enabled entities to enhance navigation and routing based on opportunities to implement Advanced Driver Assistance Systems (ADAS) functions. V2X, including cellular V2X (C-V2X) technologies, enables radio frequency (RF) communications between vehicles and other wireless nodes, such as other vehicles, roadside units (RSUs), vulnerable road users (VRUs), and cellular networks. ADAS driving functions may include functions offering varying levels of automation based on different driving context (e.g., feet off, hands on/off, eyes on/off in highway, urban, country road, etc.). For example, the ADAS driving functions may include one or more functions as known in the art such as Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS). The ADAS constraint based routing techniques provided herein may utilize one or more of these functions proactively based on one or more operating contexts and historical collaboration data. The different functions may have different functional and safety limitations based on operating environment. For example, the functions may have different operational design domains (ODDs) referring to the areas where the sub features are designed to be active or inactive (e.g., construction zones, min lane width, min road curvature, pedestrian exposure, weather, lighting etc.). The ODD information may be incorporated into route planning to enable a driver to increase the opportunities to utilize one or more functions and thus reduce the driver's workload. Current route selection algorithms are limited to objectives such as selecting the fastest route, avoid highways, minimize turns, etc.

The techniques provided herein may utilize ODD information and associated collaboration information in the route planning process to improve the utilization rate and promote optimal usage of ADAS functions. As used herein, ODD is a term for a set of operating conditions for ADAS systems and/or autonomous vehicles. These operating conditions may include environmental, geographical and time of day constraints, traffic and roadway characteristics. In an example, ODD descriptions may be organized into six top-level categories and further subcategories. The top-level categories may include indications of physical infrastructure, operational constraints, objects, connectivity, environmental conditions and zones. The physical infrastructure may include subcategories for roadway types, surfaces, edges and geometry. The operational constraints may include subcategories for speed limits and traffic conditions. Environmental conditions may include weather, illumination, and similar sub-categories. Zones may include subcategories like regions, states, school areas, construction sites and similar. ODDs may include additional categories and sub-categories.

A vehicle navigation device may be configured to increase the number of route options to the user by providing “ADAS friendly routes” which may increase the driving assistance features that may be utilized by the driver. An ADAS friendly route may be based on mapping information obtained by a navigation system. The mapping information may include an implicit indication of the ODD, or the navigation system may be configured to infer the ODD based on features included in the map data. The ODD information may include crowdsourced collaboration data provided by other vehicles. A route may be computed to reduce the number of areas with ODD constraints, and thus increase the opportunity to utilize the ADAS features (i.e., the use of routes with known constraints and/or low collaboration scores may be reduced or eliminated). Increased use of ADAS features may reduce the workload for the driver, improve safety, and/or reduce energy consumption (e.g., studies indicate that the use of ADAS conserves fuel). Other benefits may also be realized.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, on-board unit (OBU), etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. A UE disposed in a vehicle may be called an on-board unit (OBU). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

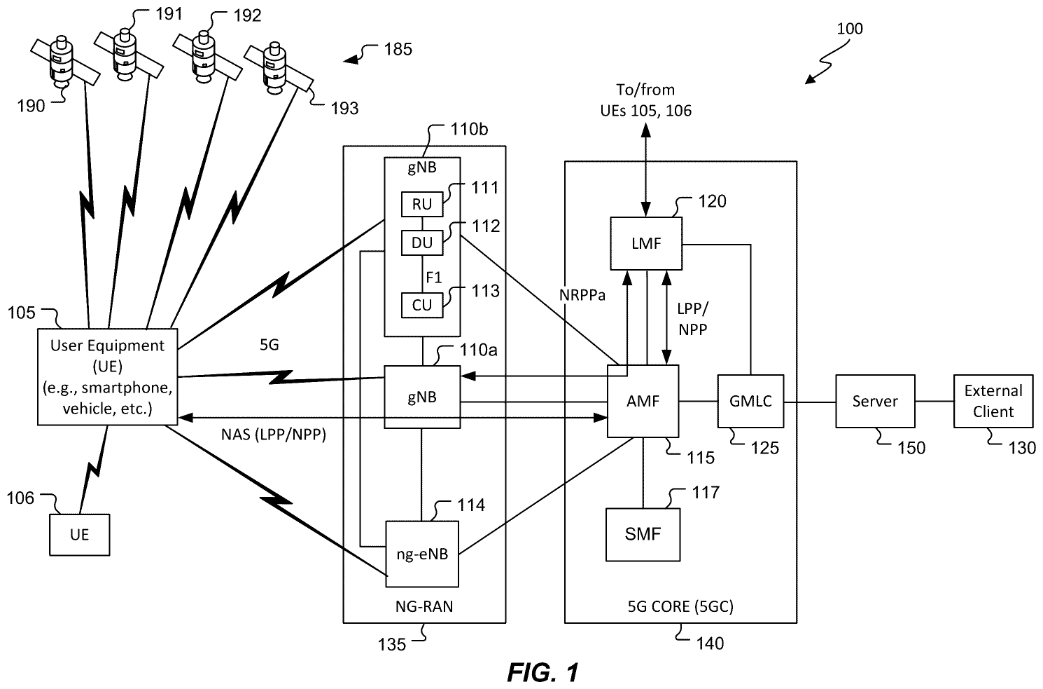

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a navigation system/OBU in a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc.). One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

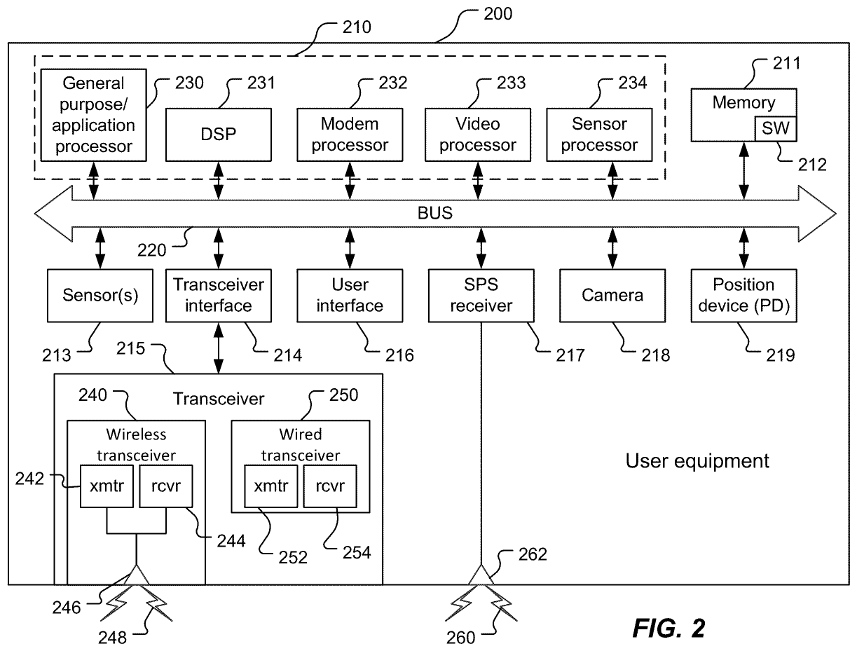

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

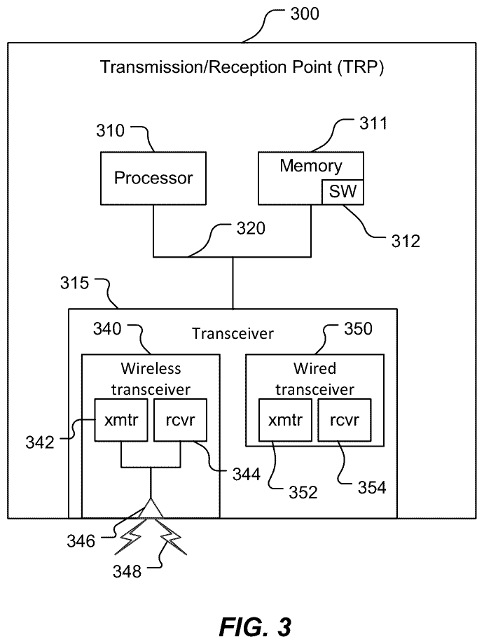

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS

(Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions). In an example, a RSU may include some or all of the components of a TRP 300.

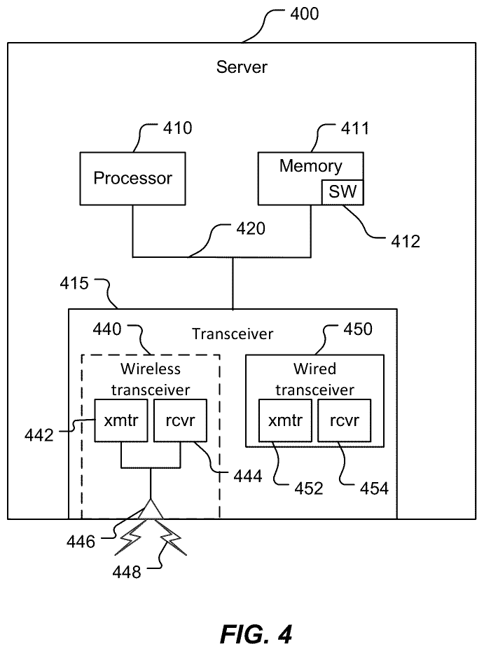

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

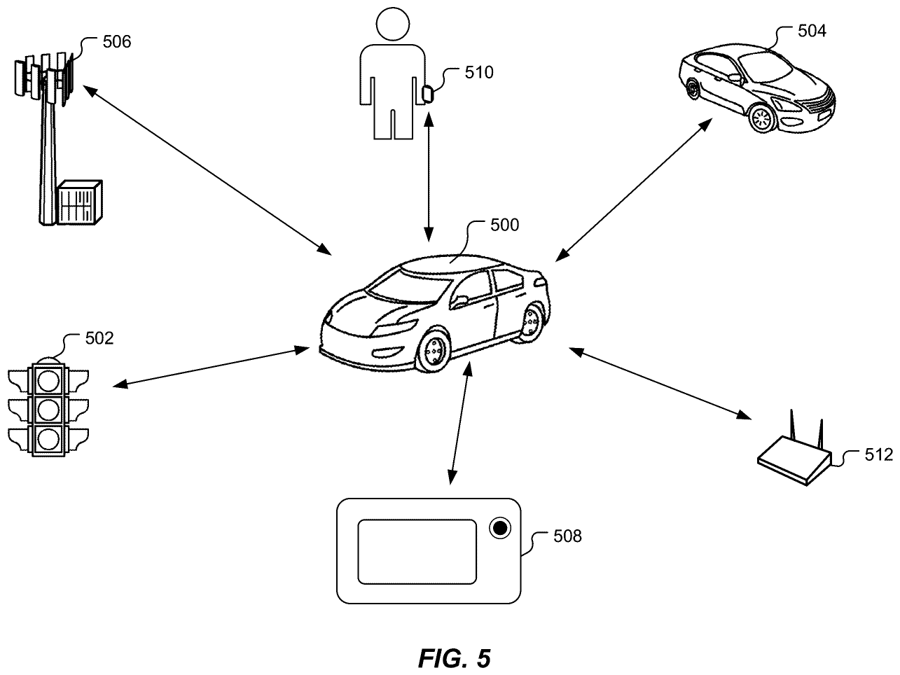

Referring to FIG. 5, a system diagram illustrating various entities configured to utilize V2X communication links is shown. In general, V2X communication involves passing information between a vehicle and any other entity that may affect or be affected by the vehicle. In an example, the supplemental ADAS constraint information described herein may be provided via one or more V2X communication links including cellular and sidelinks (e.g., Uu and PC5 interfaces). A vehicle may include an OBU which may have some or all of the components of the UE 200, and the UE 200 is an example of an OBU. The OBU may be configured to communicate with other entities such as infrastructure (e.g., a stop light), pedestrians, other vehicles, cellular networks, and other wireless nodes. In an example, V2X may encompass other more specific types of communication such as Vehicle-to-Infrastructure (V2I), Vehicle-to Vehicle (V2V), Vehicle-to-Pedestrian (V2P), Vehicle-to-Device (V2D), and Vehicle-to-Grid (V2G).

Vehicle-to Vehicle (V2V) is a communication model designed to allow vehicles or automobiles to “talk” to each other, typically by having the automobiles form a wireless ad hoc network on the roads. Vehicle-to-Infrastructure (V2I) is a communication model that allows vehicles to share information with the components that support a road or highway system, such as overhead radio-frequency identification (RFID) readers and cameras, traffic lights, lane markers, streetlights, signage and parking meters, and so forth. Similar to V2V communication, V2I communication is typically wireless and bi-directional: data from infrastructure components can be delivered to the vehicle over an ad hoc network and vice versa. Vehicle-to-Pedestrian (V2P) communications involves a vehicle or automobile being able to communicate with, or identify a broad set of road users including people walking, children being pushed in strollers, people using wheelchairs or other mobility devices, passengers embarking and disembarking buses and trains, and people riding bicycles. Vehicle-to-Device (V2D) communications consists in the exchange of information between a vehicle and any electronic device that may be connected to the vehicle itself. Vehicle-to-Grid (V2G) communication may include a vehicle communicating with an electric power grid.

These more specific types of communication are useful for fulfilling various functions. For instance, Vehicle-to-Vehicle (V2V) is especially useful for collision avoidance safety systems, while Vehicle-to-Pedestrian (V2P) is useful for safety alerts to pedestrians and bicyclists. Vehicle-to-Infrastructure (V2I) is useful for optimizing traffic light control and issuing speed advisories, while Vehicle-to-Network (V2N) is useful for providing real-time traffic updates/routing and cloud services.

As referred to herein, V2X communications may include any of these more specific types of communication, as well as any communications between a vehicle and another entity that do not fall under one of these existing communications standards. Thus, V2X is a rather broad vehicular communication system.

V2X communication may be based on Institute of Electrical and Electronics Engineers (IEEE) 802.11 wireless local area network (WLAN) technology, LTE/5G NR PC5 and/or Uu interfaces, with vehicles and entities (e.g., V2X senders) communicating through an ad-hoc network that is formed as two V2X senders come into range with each other. Cellular-based solutions also exist, such as 5G NR-based V2X, which are capable of leveraging that technology to provide secure communication, precise positioning, and efficient processing. For example, C-V2X may utilize the communications system 100 described in FIG. 1 for V2X communication links.

One benefit of V2X communication is safety. For instance, V2X communication can enable a vehicle to communicate with its surroundings, such that the vehicle can increase driver awareness and provide driving assistance to the driver. For instance, the vehicle may be aware of other moving vehicles and pedestrians on the road. The vehicle can then communicate their locations to the driver, who may be unaware. If accidents are avoided this way, then the safety of the other vehicles and pedestrians on the road is improved. This is just one use case for V2X for improving safety. Other examples of V2X use cases directed to safety include forward collision warning, lane change warning/blind spot warning, emergency electric brake light warning, intersection movement assist, emergency vehicle approaching, road works warning, and platooning.

The V2X communication standard incorporates ADAS functions configured to assist a driver to make critical decisions when it comes to lane changing, speed changing, overtaking speed, and so forth. ADAS can assist driving in challenging conditions, such as bad weather, low lighting, low visibility, and so forth. ADAS can also be used for non-line-of-sight sensing, overtaking (e.g., passing other vehicles on the road), cooperative driving, and do not pass (DNP) alerts.

V2X communication standards may also provide assistance in different modes. A first V2X mode may be utilized to increase driver awareness. For example, the vehicle can use its knowledge of the positions of the various other vehicles on the road in order to provide the driver a bird's eye view of an intersection, or to provide the driver with see-through capability when driving behind a truck (e.g., the vehicle will visually display to the driver the other vehicles on the other side of the truck that are obscured by the truck). A second V2X mode may be configured to provide cooperative driving and collision avoidance. For example, V2X can be used for platooning to tightly group vehicles on the road by enabling those vehicles to communicate and accelerate/brake simultaneously. V2X can also be used for regulating vehicle speed or overtake negotiation, in which a vehicle is able to signal its intent to overtake other vehicles in order to secure the overtaking situation. A third V2X mode may be utilized by vehicles that are configured for autonomous driving.

In an example, a vehicle 500 may be able to communicate with infrastructure 502 (e.g., a traffic light) using Vehicle-to-Infrastructure (V2I) communication. In some embodiments, the vehicle 500 may be able to communicate with other vehicles on the road, such as vehicle 504, via Vehicle-to Vehicle (V2V) communication. The vehicle 500 may be able to communicate with a cellular station 506 via a cellular protocol such as the Uu interface. The vehicle 500 may include sensors such as cameras, radar/lidar and ultrasound to implement ADAS driving and safety functions such as keep distance (KD), automatic emergency breaking (AEB), and other ADAS functions as described herein. The cellular station 506 may be a base station such as the gNB 110a, and may include some or all of the components of the TRP 300. In an example, the vehicle 500 may be able to communicate with device 508 via Vehicle-to-Device (V2D) communication. In some of such embodiments, the device 508 may be any electronic device that may be connected to the vehicle itself. For example, the device 508 may be a third party or on-board GPS navigation device, which the vehicle 500 can communicate with to obtain information available to the device 508. If the GPS navigation device had information regarding congested routes, traffic density, the location of other vehicles on the road with similar devices, and so forth, the vehicle 500 may be able to obtain all that information. In an example, the device 508 may include a user interface display, audio, and/or haptic components configured to provide alerts to a user.

In an example, the vehicle 500 may be able to detect a UE, or other wireless device, carried by a pedestrian 510 via Vehicle-to-Pedestrian (V2P) technology. For instance, the vehicle 500 may have a detection method such as cameras or sensors that allow the vehicle 500 to detect and confirm the presence of pedestrian 510 on the road. Pedestrian 510 may encompass a broad set of people, including people walking, children being pushed in strollers, people using wheelchairs or other mobility devices, passengers embarking and disembarking buses and trains, people riding bicycles, and so forth.

In an example, the vehicle 500 may be configured to communicate with a roadside unit (RSU) 512, or other networked devices such as an AP. The RSU may be disposed in high traffic areas and may be configured to perform the messaging techniques described herein. The RSU 512 may include some or all of the components of the TRP 300. In general, a RSU is less capable than a TRP since the coverage area of the RSU is less than the TRP.

In some embodiments, the vehicle 500 and the other entities in FIG. 5, may also be able to receive information from a network or server, such as the server 400 (not shown in FIG. 5). The vehicle 500 may be able to communicate with the network and server to receive information about the locations and capabilities of infrastructure 502, vehicle 504, cellular stations 506, pedestrian 510, and the RSU 512 without having to communicate with those entities directly.

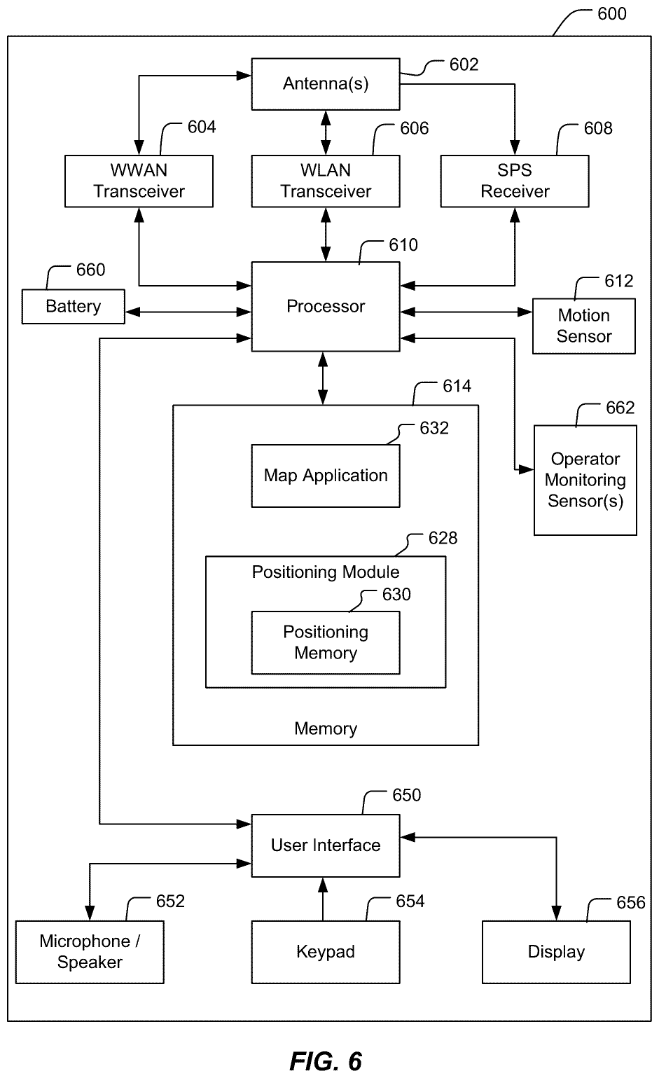

Referring to FIG. 6, an example mobile device which is capable of providing ADAS constraint based routing is shown. FIG. 6 is a block diagram illustrating various components of an example mobile device 600. In an example, the mobile device 600 may have some or all of the components of the UE 200. The mobile device 600 may be an OBU or other electronic devices, such as the device 508 in FIG. 5. The mobile device 600 may be configured to communicate with elements in a V2X network as described in FIG. 5. A vehicle, such as the vehicle 500 with reference to FIG. 5, may have an in-vehicle display, such as display 656 described below, and on-board navigation computer, such as processor 610 described below. The features or functions illustrated in the example of FIG. 6 may be further subdivided into two or more of the features or functions illustrated in FIG. 6 may be combined.

The mobile device 600 may include one or more wireless wide area network (WWAN) transceiver(s) 604 that may be connected to one or more antennas 602. The WWAN transceiver 604 comprises suitable devices, hardware, and/or software for communicating with and/or detecting signals to/from WWAN access points and/or directly with other wireless devices within a network. In an example, the WWAN transceiver may be configured to communicate with the wireless communication system 100 described in FIG. 1.

The mobile device 600 may also include one or more wireless local area network (WLAN) transceivers (such as illustrated WLAN transceiver 606) that may be connected to one or more antennas 602. The WLAN transceiver 606 comprises suitable devices, hardware, and/or software for communicating with and/or detecting signals to/from WLAN access points and/or directly with other wireless devices within a network. In an example, the WLAN transceiver 606 may comprise a Wi-Fi (IEEE 802.11x) communication system suitable for communicating with one or more wireless access points. The WLAN transceiver 606 may comprise another type of local area network or personal area network (PAN). Additionally, any other type of wireless networking technologies may be used, for example, Ultra-Wide Band, Bluetooth, ZigBee, wireless USB, etc. As described above, V2X communication may include communication using WLAN transceiver 606 with various vehicles and/or entities.

A satellite positioning system (SPS) receiver 608 may also be included in the mobile device 600. The SPS receiver 608 may be connected to the one or more antennas 602 for receiving satellite signals. The SPS receiver 608 may comprise any suitable hardware and/or software for receiving and processing SPS signals. The SPS receiver 608 requests information and operations as appropriate from the other systems and performs the calculations for determining the position of the mobile device 600 using measurements obtained by any suitable SPS algorithm. In some embodiments, the mobile device 600 is within a vehicle (e.g., vehicle 500 in FIG. 5) and the determined position of the mobile device 600 can be used to track the vehicle as it travels along a route.

A motion sensor 612 may be coupled to a processor 610 to provide movement and/or orientation information, which is independent of motion data derived from signals, received by the WWAN transceiver 604, the WLAN transceiver 606 and the SPS receiver 608. The motion sensor 612 may utilize an accelerometer (e.g., a microelectromechanical systems device), a gyroscope, a geomagnetic sensor (e.g., a compass), an altimeter (e.g., a barometric pressure altimeter), and/or any other type of movement detection sensor. Moreover, the motion sensor 612 may include a plurality of different types of devices and combine their outputs in order to provide motion information. For example, the motion sensor 612 may use a combination of a multi-axis accelerometer and orientation sensors to provide the ability to compute positions in 2-D and/or 3-D coordinate systems. In some embodiments, the computed positions from the motion sensor 612 may be used with the calculated positions from the SPS receiver 608 in order to more accurately determine the position of the mobile device 600 and any associated vehicle containing the mobile device 600.

The mobile device 600 may include, or be operably coupled to, one or more operator monitoring sensors 662 configured to obtain operator collaboration information. The operator monitoring sensors 662 may include a Driver Monitoring System (DMS) and an Occupant Monitoring System (OMS). A DMS and OMS may include one or more cameras directed towards the respective vehicle operator and/or occupant to provide real-time evaluation of the presence and state of the operator and occupant. The operator monitoring sensors 662 may be configured to monitor the level of vigilance of the operator and detect drowsiness signals. The processor 610 may be configured to alert the operator via the user interface 650 (or other haptic interfaces such as a vibrating steering wheel or seat) and initiate an intervention to manage control of the vehicle. The operator monitoring sensors 662 may be configured to detect indications of physical actions performed in response to a silent failure, such as when an ADAS function is activated without providing an alert. For example, the operator monitoring sensors 662 may be configured to detect a duration of time required by a vehicle operator to react when a driving function is activated.

The information obtained by the operator monitoring sensors 662 may be utilized to determine a level of collaboration between the operator and the vehicle. For example, eye gaze direction may be monitored (e.g., eyes off road, long off-road glances, eye behavior associated with a confused state), and head posture may be used to detect distraction and/or drowsiness. Steering wheel sensors may be utilized to measure periods of no steering or ineffective collaborative steering (e.g., when the operator's hands are off the steering wheel when they are supposed to be on). Other operator monitoring sensors 662 may include brake detection such that the processor 610 may be configured to determine if the time required by the operator to react to a system initiated request is prolonged (e.g., greater than a threshold value). Other inputs such as delayed counter steering may be used to determine the operator's level of collaboration. Other non-driving related tasks, such as tuning a radio, utilizing voice commands, interacting with an instrument cluster, or engaging with other systems in the vehicle may be utilized as an operator monitoring sensor.

The processor 610 may be connected to the WWAN transceiver 604, WLAN transceiver 606, the SPS receiver 608 and the motion sensor 612. The processor 610 may include one or more microprocessors, microcontrollers, and/or digital signal processors that provide processing functions, as well as other calculation and control functionality. The processor 610 may also include memory 614 for storing data and software instructions for executing programmed functionality within the mobile device 600. The memory 614 may be on-board the processor 610 (e.g., within the same integrated circuit package), and/or the memory may be external memory to the processor and functionally coupled over a data bus.

A number of software modules and data tables may reside in memory 614 and be utilized by the processor 610 in order to manage communications, route planning, and positioning determination functionality. As illustrated in FIG. 6, memory 614 may include and/or otherwise receive a positioning module 628 and a map application 632 capable of generating a map associated with a computed location determined by the positioning module 628, or additionally or alternatively, a map comprising a plurality of routes from, for example, a destination address and a source address. The positioning memory 630 may be configured to store map information including ODD and collaboration information. The memory contents as shown in FIG. 6 are examples, and as such the functionality of the modules and/or data structures may be combined, separated, and/or structured in different ways depending upon the implementation of the mobile device 600. In an example, a battery 660 may be coupled to the processor 610, wherein the battery 660 may supply power to the processor 610 and various other modules and components located on the mobile device 600 through appropriate circuitry and/or under control of the processor 610.

The positioning module 628 may be capable of determining a position based on inputs from wireless signal measurements from WWAN transceiver 604, signal measurements from the WLAN transceiver 606, data received from SPS receiver 608, and/or data from motion sensor 612. For instance, the positioning module 628 may direct the processor 610 to take satellite signals from the SPS receiver 608 to determine the global position of the mobile device 600. This position of the mobile device 600 may then be mapped relative to the locations of the routes displayed in the navigation map. The accuracy of the position of the mobile device 600 may be further improved by taking data from neighboring devices or vehicles via the WWAN transceiver 604 and WLAN transceiver 606 (for example, using V2X communications), in order to determine the position of the mobile device 600 relative to neighboring devices or vehicles and make adjustments to the satellite-based position. Additionally, the accuracy of the position of the mobile device 600 may be further improved by taking data from the motion sensor 612, which will provide information about the distance between the mobile device 600 and surrounding objects or landmarks.

The map application 632 can be capable of generating an image of a map of an area surrounding the position determined by the positioning module 628 above. Additionally or alternatively, the map application 632 can be capable of generating an image of a map of an area surrounding any given position based on the map application receiving coordinates of a location. To generate the image, using the computed or received coordinates, the map application 632 can access data from a map server (not illustrated) via, for example, WWAN transceiver 604 or WLAN transceiver 606.

While the modules shown in FIG. 6 are illustrated in the example as being contained in the memory 614, it is recognized that in certain implementations such procedures may be provided for or otherwise operatively arranged using other or additional mechanisms. For example, all or part of the positioning module 628 may be provided in firmware. Also, some aspects of positioning module 628 may be performed in WWAN transceiver 604.

The mobile device 600 may include a user interface 650, which provides any suitable interface systems, such as a microphone/speaker 652, keypad 654, and display 656 that allows user interaction with the mobile device 600. The microphone/speaker 652 provides for voice communication services using the WWAN transceiver 604 and/or the WLAN transceiver 606. The microphone/speaker 652 may be configured to provide audio-based navigation instructions. Although illustrated as a single device, it is understood that microphone/speaker 652 may comprise a separate microphone device and a separate speaker device. The keypad 654 comprises any suitable buttons for user input. The display 656 comprises any suitable display, such as, for example, a liquid crystal display, and may further include a touchscreen display for additional or alternative user input modes. The user interface 650 is illustrated as a hardware user interface, however, can also be understood to include a graphical user interface displayed on a touchscreen (for example, integrated with display 656) allowing output to a user and receipt of input from the user. Input from, and output to, a user can be mediated through the user interface 650 such that the mobile device, for example the processor 610 or other components, can receive user input from the user interface 650 and provide output to the user via the user interface 650.

The processor 610 may include forms of logic suitable for performing at least the techniques provided herein. For example, the processor 610 may obtain position or location information via one or more transceivers or sensors, such as the WWAN transceiver 604, WLAN transceiver 606, the SPS receiver 608, and or the motion sensor 612. Using this location information, the processor 610 may utilize the positioning module 628 and the map application 632 in order to map out the location of the mobile device 600 (and the vehicle the mobile device 600 is in) relative to one or more routes between a source address and a destination address in a navigation map. The map application 632 may include ODD and associated ADAS collaboration information for potential routes to the destination address. The processor 610 may then cause the navigation map along with the one or more routes to be displayed in the display 656. The navigation map can also be provided in the context of the user interface 650, such that a user can select a specific route presented through the navigation map.

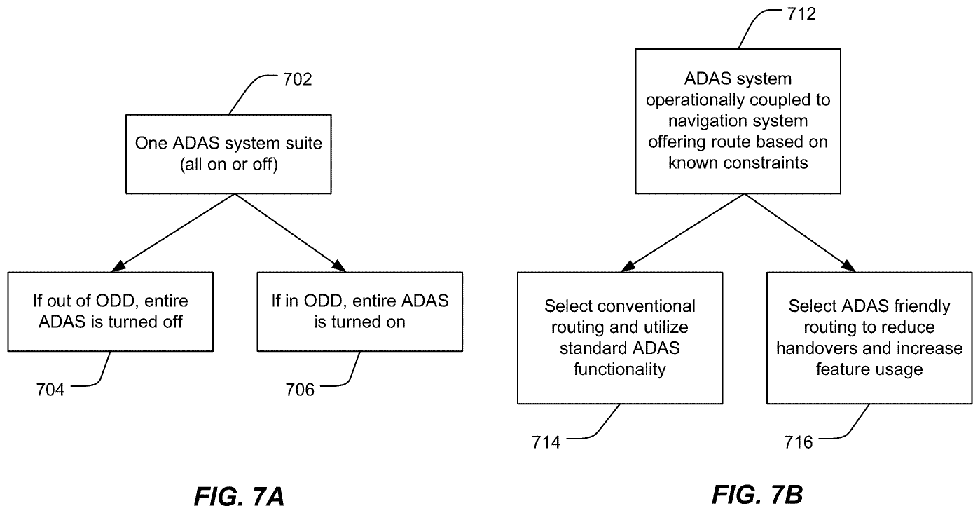

Referring to FIG. 7A, a block diagram of a method for utilizing ADAS functions is shown. At stage 702 an ADAS system in the vehicle 500 may be configured to be active or inactive. The mobile device 600 may be configured to execute the ADAS system, or the mobile device 600 may be operably coupled to one or more components of the ADAS. The ADAS system may be configured in either an on state or an off state. For example, at stage 704 if the vehicle is out of an ODD in which the ADAS may function, then the ADAS system is not active. Conversely, if the vehicle is located in an ODD which the ADAS can function, the ADAS system is activated at stage 706. The method in FIG. 7A is typical of existing ADAS systems in that the ADAS reacts to the current position of the vehicle and does not provide routing information based on different ODDs along potential routes.

Referring to FIG. 7B, a block diagram of an example method for ADAS constraint based routing is shown. In this example, at stage 712, an ADAS system which may be operationally coupled to a navigation system (e.g., the mobile device 600, the device 508, the UE 200) configured to provide routing based on known ADAS constraints. In an example, the mobile device 600 may be configured as the ADAS system. At stage 714, the ADAS system may be configured to utilize standard ADAS functionality based on conventional routing. That is, the ADAS system may be activated or deactivated based on the location along a route as described in FIG. 7A. Alternatively, at stage 716, the navigation system may determine ADAS friendly routes which may reduce handovers between a vehicle and the operator and/or increase ADAS function usage. The ADAS friendly routes may be based on the different ODDs along potential routes and the corresponding collaboration values associated with the ODDs. In operation, the mobile device 600 may receive supplemental V2X information via the WWAN transceiver 604 (e.g., cellular network) and/or the WLAN transceiver 606 (e.g., from a RSU via the PC5 interface). The supplemental V2X information may include ODD information based on geographic areas (e.g., map data) and crowdsourced collaboration information as described herein.

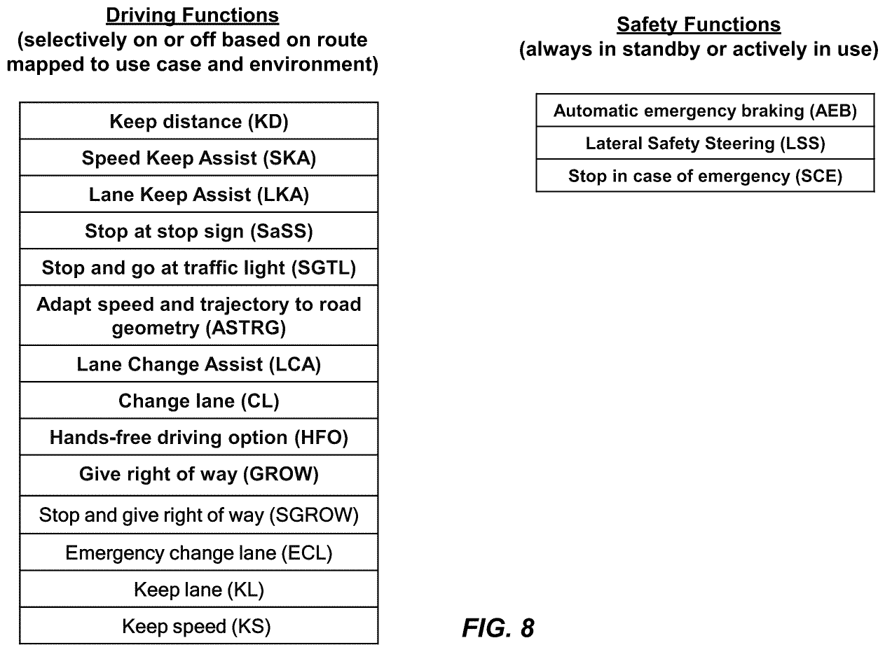

Referring to FIG. 8, example ADAS functions for driving and safety use cases are shown. The ADAS functions in FIG. 8 represent commercially available ADAS systems as an example, and not a limitation, as the techniques provided herein may utilize future ADAS functions. In general, safety functions such as automatic emergency breaking (AEB), lateral safety steering (LSS), and stop in case of emergency (SCE) may be in a standby mode (or activated) independent of location. That is, the route planning features may not be based on the expected utilization of these ADAS safety functions. The ADAS driving functions, however, may be associated with one or more ODDs and corresponding collaboration information. The driving functions may be based on current Adaptive Cruise Control (ACC) functions such as Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS). Other functions may also be used for route planning.

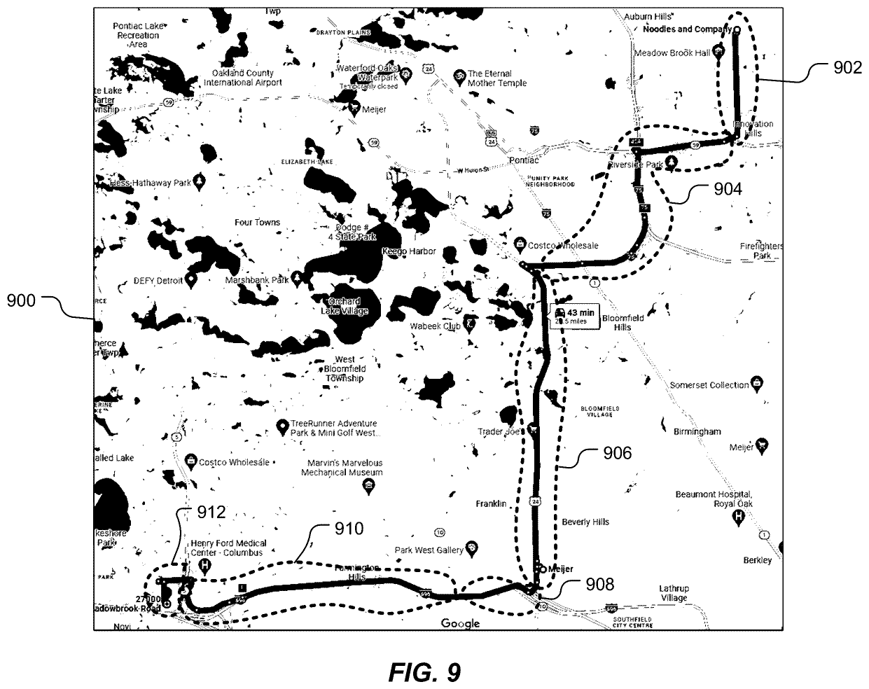

In operation, referring to FIG. 9, a navigational route may traverse different ODDs as shown. FIG. 9 includes a map with an example conventional route 900 generated by a route planning application (e.g., Google Maps, Waze, Apple Maps, etc.) executing on a mobile device. In an example, the ODDs may be based on road classifications such as a residential area, freeway driving, and divided highway driving. Other ODDs may include areas that are impacted by road design factors such as lane width (e.g., tight lanes with widths below 3 meters), construction zones, road curvature, pedestrian-dense areas, road friction (e.g., in certain weather conditions), and areas impacted by sun glare at certain times of the day.

The conventional route 900 is an example use case for a typical daily commute which involves urban roads, highways with and without construction, entrance and exit ramps for the highways, simple and complex intersections, and a U-turn. The conventional route 900 may have areas supported and unsupported by the vehicle's ADAS package. For example, the conventional route 900 includes a first portion 902 classified as a residential area ODD, which may be associated with ADAS driving functions such as hands on lane keep assist (LKA), speed keep assist (SKA), stop at stop sign (SaSS) and stop and go at traffic light (SGTL). A second portion 904 may be classified as a freeway driving ODD and associated with hands-free driving option (HFO) and lane change assist (LCA), as well as LKA and SKA. A third portion 906 may be classified as a divided highway driving ODD and associated with HFO, LKA, and SKA functions. A fourth portion 908 may be an ODD that is unsupported and thus no ADAS functions would be offered (e.g., construction zone). A fifth portion 910 may also be classified as a freeway driving ODD and associated with HFO, LCA, LKA and SKA functions. A sixth portion 912 may also be unsupported because the vehicle will be expected to make a U-turn (or other active driving requirement). The techniques provided herein may enable a route planning application to analyze different routes based on supplemental ADAS constraint information (e.g., ODDs, and associated collaboration information) to generate one or more ADAS friendly routes, where the vehicle's ADAS functions may be activated for longer durations.

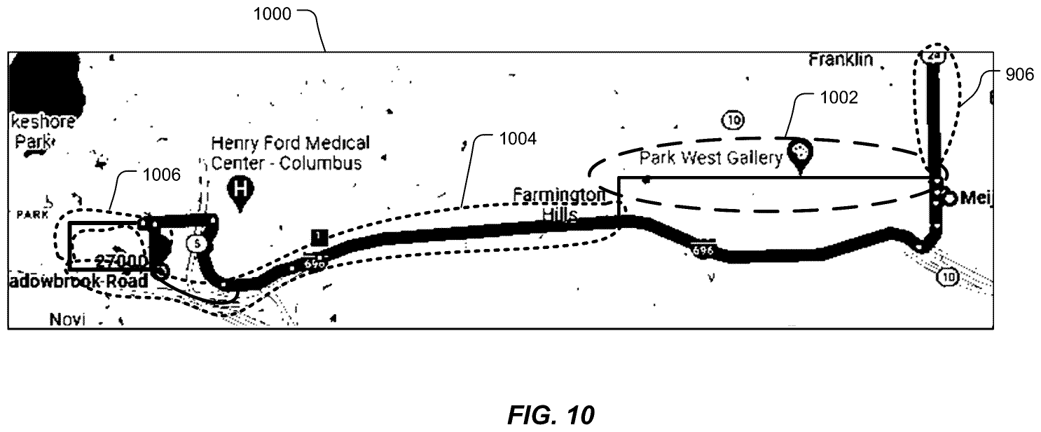

Referring to FIG. 10, a portion of the street-level navigation map of FIG. 9 indicting routing options utilizing supplemental ADAS constraint information is shown. An ADAS friendly route 1000 avoids the unsupported fourth portion 908 and sixth portion 912 in the conventional route 900, and provides the option for a first ADAS friendly portion 1002, a second ADAS friendly portion 1004, and a third ADAS friendly portion 1006. The first ADAS friendly portion 1002 may include a divided highway ODD associated with HFO, LKA and SKA functions, and a residential area ODD associated with LKA and SKA functions. The second ADAS friendly portion 1004 may be a freeway ODD associated with LCA, LKA and SKA functions. The third ADAS friendly portion 1006 is another residential ODD that is associated with LKA and SKA functions. As compared to the conventional route 900, the ADAS friendly route 1000 provides an increased opportunity for ADAS functions to remain active. Increasing the use of ADAS may increase user satisfaction because it would make such a daily commute (e.g., a drive to and from work) much easier by reducing workload, even if the route may require a few additional minutes of travel time.

A routing application, or other applications executing on a navigation system, mobile device, OBU or other types of UEs, may be configured to determine an ADAS friendly route based on the ODD classifications associated with portions of different route options. In an example, the ODD classification may be included in map data in a routing application, and/or received from a network resource (e.g., via the communication system 100). The ODD information may also include supplemental ADAS constraint information such as crowdsourced collaboration information. For example, the mobile device 600 may be configured to report ADAS collaboration and location information to a network resource (e.g., external client 130). The ADAS collaboration information received from multiple vehicles may be associated with an ODD and then subsequently provided to other vehicles for use in ADAS friendly routing. The ADAS collaboration information may be indications of interactions between a human operator and a vehicle and may be recorded via the operator monitoring sensors 662 (e.g., a DMS).

In general, collaborative driving entails enhancing human capabilities rather than (incompletely) taking over parts of driving of tasks (e.g., some aspects of lane keeping, some aspects of distance and speed control) while keeping a driver in the loop or on the loop. In collaborative driving, the vehicle operator may maintain situational awareness and react in a timely manner when encountering potential hazardous scenarios. Such reactions may include executing avoidance maneuvers during hazardous scenarios to reduce the chance of harmful consequences. The operator may be considered in the loop when they are in physical control of the vehicle and monitoring the driving situation. An operator is on the loop when they are not in physical control of the vehicle, but monitoring the driving situation. The operator is out of the loop when not in physical control of the vehicle, and not monitoring the driving situation, or in physical control of the vehicle but not monitoring the driving situation.

The level of collaboration between the operator and the vehicle may be impacted by many direct and indirect factors. For example, indirect metrics of ineffective collaboration may include improper steering, lack of adaptations to the individual driver in the present context (e.g., stressed, calm, tired, aggressive), and the amount of time an operator spends performing non-driving related tasks (NDRTs, e.g., using a mobile device, center stack use, etc.), interacting with passengers, eating & drinking, or performing a hygiene task (e.g., putting on make-up), or other actions which may distract a driver. The operator monitoring sensors 662 may be configured to provide direct metrics of ineffective collaboration. DMS hardware including IR and/or visual spectrum cameras may be configured to track eye-gaze direction to determine if the vehicle operator has their eyes off of the road, or is making off-road glances. Head posture may be tracked to detect driver distraction/drowsiness. Steering sensors may be configured to provide feedback on steering efforts to detect ineffective collaborative steering or sense when the operator removes their hands from the steering assembly when they are supposed to be actively steering (e.g., with hands on the steering assembly). Operator response time may also be used as an indication of ineffective collaboration. For example, the operator monitoring sensors 662 may be configured to detect the time required for the operator to take over control of the vehicle after a system initiated request. Short take over times may be an indication of higher collaboration as compared to prolonged take over times. The timing of other actions such as counter steering and braking may also be monitored. The level of engagement with the vehicle may be based in part on the frequency and/or duration of non-driving related tasks such as engagement with an instrument cluster, center display (e.g., the display 656), voice interaction, steering wheel controls, horn activation, and other such non-driving activities available to the operator. In an example, the microphone/speaker 652 may be configured to sense the operator's voice to determine whether the operator is engaged in conversation and/or distracted by the vehicle passengers (e.g., trying to resolve disputes of siblings in a back seat of the vehicle). Other sensors and device states may be used to determine the operator's level of engagement.

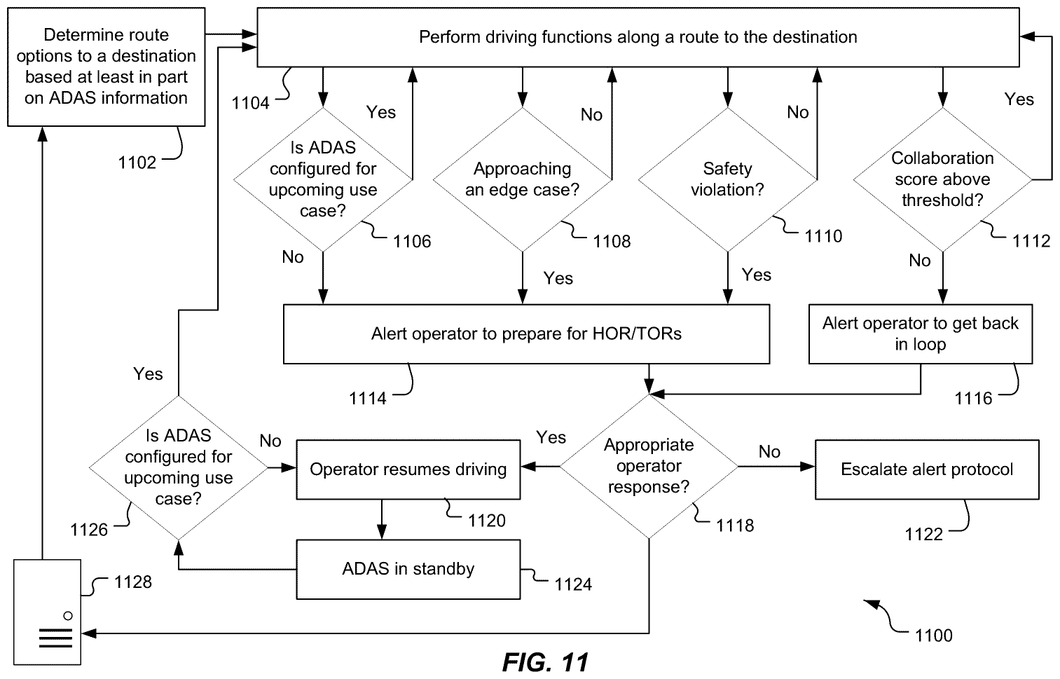

Referring to FIG. 11, with further reference to FIGS. 1-10, a process 1100 for obtaining ADAS collaboration information for use in ADAS routing includes the stages shown. The process 1100 is, however, an example and not limiting. The process 1100 may be altered, e.g., by having stages added, removed, rearranged, combined, performed concurrently, and/or having single stages split into multiple stages. The process 1100 may be performed by a vehicle navigation system, such as the UE 200 and the mobile device 600.

At stage 1102, the process includes determining route options to a destination based at least in part on ADAS constraint information. The mobile device 600 may be configured with a route planning application (e.g., the map application 632) and may receive map information and ADAS constraint information via a network (e.g., V2X, cellular, WLAN, etc.). The map information may include road and geographic feature information which may be associated with ODDs. For example, the map information may have indication of road types (e.g., urban, highway, suburban, city), road details (e.g., curve radius, lane split/merge descriptions, lane width, weather, barriers, rotaries, intersections), and road semantics (e.g., traffic lights, traffic signs, speed limits). The map information may include temporal information such as the location of construction zones, traffic information, and local weather conditions (and corresponding road conditions). In an example, the map information may include dynamic information such as the location of emergency vehicles, truck density, pedestrian information, or other information which may impact a route to a destination. In an example, the map information may include explicit ODD classifications for areas.

The ADAS constraint information may include crowdsourced collaboration information associated with different route options. The crowdsourced collaboration information may include collaboration scores indicating physical action performed by respective operators of vehicles when ADAS functions were active (e.g., in use) in different locations along a potential route. The crowdsourced collaboration information may enable the route planning application to improve the generation of ADAS friendly routes (e.g., as described in FIG. 10) because the behavior of actual operators along the potential routes may be incorporated into the route planning process. The collaboration scores generated for previous operations may help overcome use cases when alleged reliable routes (e.g., including ODD with high confidence ADAS correlations) still turn dangerous because familiarity and over trust may impact human supervision. Similarly, if a location is associated with high collaboration scores, that location may be avoided if the current vehicle operator has demonstrated ineffective collaboration. This use case may apply to locations with unique right of way rules which are context based.

The ADAS constraint information may include historical collaboration information associated with a driver and the ADAS friendly routes may be based at least in part on the driver's historical collaboration performance. In a low cognitive load use case, an operator may be familiar with a route and thus may drive arrogantly and pay less attention (i.e., mentally on autopilot and may succumb to boredom or distractions). In this use case, the mobile device 600 (or remote server) may store indications of the operator's typical routes, typical behaviors in familiar and unfamiliar routes, and then recommend routes which may maximize positive operator-system collaboration (i.e., reduce suggestions to routes where an operator exhibited high rates of inattention, dangerous driving habits, etc.). In a high cognitive load use case, unexpected/dangerous conditions may arise and the operator may be caught off guard, which will increase their inputs and anxiety if attentive, but may have little to no affect if the operator is inattentive. This use case is more likely in urban settings because of traffic volumes, pedestrians, and other factors. Other examples of high cognitive load use cases may include ego lane ending, ego lane turning into highway exit (unintended), ego will miss desired highway exit, accident nearby, traffic jam, sudden stops, emergency vehicle in area, roundabouts, U-turns, dangerous weather conditions (friction-impacting or visual-impacting or both), and more. The ADAS constraint information received by the mobile device may enable the route planning application to generate route options which reduce the likelihood of these unexpected scenarios occurring by planning a route that avoids situations that are known to have poor collaboration score based on the crowdsourced data and/or historical data associated with the operator. The route planning application may be configured to generate routes based on a low cognitive load (e.g., familiar routes) and then monitor for indicators of high cognitive load (e.g., fatigue, head posture not aligning with traffic context etc.) to ensure driver collaboration is above permissible limits during the route.

In an example, the ADAS constraint information may include implicit preferences provided by the operator (e.g., avoid areas with large trucks, avoid routes at a specific time of day, day of the week, etc.). The routing application may include a user input process to receive the operator's routing preferences.

Once the vehicle proceeds along a selected route, at stage 1104 the mobile device 600 may be configured to perform driving functions along the route to the destination. The functions include determining the current location of the vehicle (e.g., via satellite and/or terrestrial navigation techniques) and determining the appropriate ADAS functions to activate based on the ODD of the current and upcoming locations. At stage 1106, if an ADAS function is not configured for an upcoming use case (e.g., ODD, user preference, etc.), the mobile device 600 may be configured to alert the operator to prepare for Hands-On (HO) operations. For example, the mobile device 600 may instruct the ADAS system to provide a Hands-On Request (HOR) and/or Take Over Request (TOR) to the operator at stage 1114.

At stage 1108, the process 1100 may be configured to determine if the vehicle is approaching an area associated with edge cases such as a low cognitive load (e.g., where the current operator, or other operators in the crowdsourced collaboration information, have demonstrated an inattentive posture), high cognitive load (e.g., where driving conditions are dangerous if a driver is caught off guard), or other areas and/or ODDs where the operator has provided preferences for limited ADAS functionality. An HOR/TOR indication may be provided to the operator at stage 1114 as the vehicle approaches such an edge case. At stage 1110, the process 1100 may determine if an approaching area includes an increased safety risk to the operator and vehicle. For example, the navigation system may receive road alerts for traffic, accidents, construction sites, etc. which may impact the ability of the ADAS system to safely control the vehicle. In an example, the presence of emergency vehicles (e.g., ambulance, police, fire trucks, etc.) may trigger a safety concern. The process 1100 may generate a HOR/TOR message at stage 1114 in response to the potential safety violation.

At stage 1112, the process includes determining whether the operator's current collaboration score is above an established threshold. The operator monitoring sensors 662, and other sensors in the vehicle as described herein, may be used to monitor the operator and establish a collaboration score as a figure of merit to describe the operator's attention level. The ADAS functionality will continue in stage 1104 when the collaboration score (e.g., operator attention level) is above an established threshold. In an example, the threshold value may be based on crowdsourced collaboration scores for other vehicles that have traversed the location. The threshold values may be dynamically adjusted based on current conditions. For example, heavy weather or traffic may cause an increase in the threshold value (e.g., require increased attention), or sparse traffic and clear weather may cause a decrease in the threshold value. Other factors may also be used to modify the collaboration threshold value. If the operator's collaboration score drops below the threshold value, the process 1100 includes providing an alert to the operator at stage 1116 in an effort to get the operator to get in the loop (e.g., increase their attention level). The alert may include a sound, display, haptic, or combinations of these and other actions configured to obtain the operator's attention and respond to the current operational situation. In an example, when the collaboration score drops below a threshold, in addition to in-cabin alerts, the vehicle dynamics may also be altered to drive more conservatively thereby becoming kinesthetic feedback for driver to get back in the loop (e.g., speed reduction, brake jerk, distance or time gap increase to other vehicles).

At stage 1118, the process 1100 determines if the operator's response to the HOR/TOR at stage 1114 or the alert at stage 1116 are correct under the circumstances. An appropriate response may include getting back in the loop (e.g., return eyes to the road, place hands on the wheel, etc.), or to perform an interaction with the vehicle (e.g., adjust steering, apply acceleration, apply breaks in within a designated time, adjust relative position to other vehicles, etc.). If the operator does not demonstrate an appropriate response, then the alert protocol may be escalated at stage 1122. An escalated alert may include increasing the volume or changing the tone of audible alerts, or making other audio, visual or haptic responses to alert the operator that their current response is not appropriate. If the operator had demonstrated an appropriate response at stage 1118, then the operator may resume control of the vehicle at stage 1120 and the ADAS system may be placed in standby at stage 1124. While the ADAS is in standby, the process 1100 may continue to monitor progress along the route and determine if ADAS functions may be activated for upcoming use cases at stage 1126. The upcoming use cases may be ODD's associated with ADAS functions as described in FIGS. 8-10. Other use cases may be based on user preferences and other scenarios which may enable the operator to benefit from the activation of the ADAS system. The process 1100 may activate the ADAS and iterate to perform the navigation and safety functions at stage 1104.

The operator responses from stage 1118 and collaboration score information from stage 1112 may be provided to a network resource 1128 such as a server 400, an external client 130, or other edge server. The communication system 100 (e.g., cellular network) may be configured to receive collaboration information and location information from the vehicle. Other signaling technologies such as described in FIG. 5 (e.g., V2X, WiFi, BLE, etc.) may be used to obtain the collaboration and location information. For example, an RSU may be configured to receive the collaboration and location information via the PC5 interface. The network resource 1128 may be configured as a crowdsourcing server configured to receive collaboration information from multiple vehicles and analyze the received information to generate collaboration scores for different locations. The network resource 1128 may be configured to perform statistical functions on the received collaboration information (e.g., determine means, averages, deviations, etc.) to assign collaboration scores for use in future ADAS friendly routing decisions. For example, the collaboration information may be the figures of merit assigned to individual drivers driving in a location and the network resource 1128 may be configured to determine the average, mean and standard deviation for the received figures of merit. In an example, collaboration score of drivers may be calculated periodically at a fleet level to ensure and improve the effectiveness of navigation route optimization aimed at better human automation collaboration. Other correlations and analysis functions may be performed on the crowdsourced data to improve the implementation of ADAS friendly routing and enable improved collaboration between operators and ADAS systems along those routes.

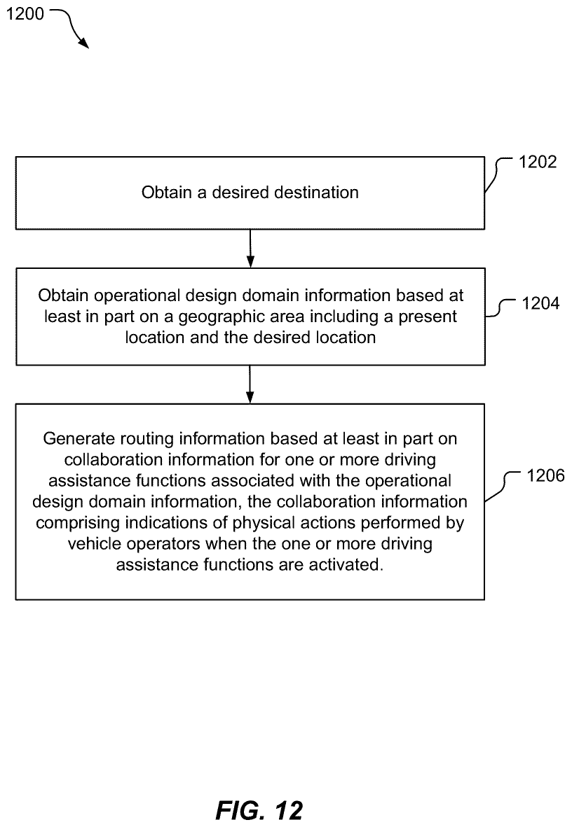

Referring to FIG. 12, with further reference to FIGS. 1-11, a method 1200 for generating routing information for a vehicle configured with an advanced driver assistance system includes the stages shown. The method 1200 is, however, an example and not limiting. The method 1200 may be altered, e.g., by having stages added, removed, rearranged, combined, performed concurrently, and/or having single stages split into multiple stages.

At stage 1202, the method includes obtaining a desired destination. The mobile device 600, including the processor 610 and the user interface 650, is a means for obtaining the desired destination. In an example, the mobile device 600 is configured to execute a navigation application including route planning functions. For example, the memory 614 may include a positioning module 628 and the map application 632. An operator may be configured to provide a desired destination (e.g., via street address, common name, lat./long. coordinates, etc.) via the user interface 650 (via the keypad 654, microphone 652, display 656). Other inputs, such as an application executing on the UE 200 which is communicatively coupled to the mobile device 600, may be configured to receive the desired destination from the operator.

At stage 1204, the method includes obtaining operational design domain information based at least in part on a geographic area including a present location and the desired location. The mobile device 600, including the processor 610 and the transceiver 604, is a means for obtaining the ODD information. The map application 632 may include map data and associated ODD information for locations in the geographic area. For example, referring to FIGS. 8-10, different ODDs may be associated with the use of one or more ADAS driving functions. The ODD information may persist in the memory 614 and/or the positioning module 628 may be configured to obtain the ODD information from a network resource, such as an external client 130, the LMF 120, the network resource 1128, or other networked server. In an example, the external client 130 may include an application programming interface (API) and the mobile device 600 may be configured to query the API to obtain map and/or ODD information based on the geographic area. The ODD information may include collaboration information based on the operator's prior driving experiences and/or from crowdsourced data as described in FIG. 11.

At stage 1206, the method includes generating routing information based at least in part on collaboration information for one or more driving assistance functions associated with the operational design domain information, the collaboration information comprising indications of physical actions performed by vehicle operators when the one or more driving assistance functions are activated. The mobile device 600, including the processor 610, is a means for generating the route information. In an example, the ODD information may be associated with an area as described in FIGS. 9 and 10, and the one or more driving assistance functions may include some or all of the ADAS functions described in FIG. 8. Other driving assistance functions may also be used. The collaboration information may be acquired via wireless signaling in the communication system 100, or other V2X technologies. In an example, the collaboration information may be acquired from a local memory (e.g., the memory 211). The collaboration information may be collaboration scores associated with the performance of the current operator, and/or other operators, who have operated an ADAS equipped vehicle in the areas along the route and/or or areas with similar ODD criteria. The collaboration information provides an indication of the effectiveness of the operator/vehicle interface in the designated ODD. The physical actions may be the actions observed by operator monitoring sensors 662 or other sensors in a vehicle. For example, the physical actions may include eye gaze direction (e.g., eyes off road, long off-road glances, eye behavior associated with a confused state), head posture and other body motions which may be detected as an indication of distraction and/or drowsiness. An indication of physical action may be the time required by a driver to react to a silent failure. As used herein, a silent failure is when an ADAS function is activated without providing an alert to the driver. The physical actions may be obtained by steering wheel sensors and used to measure periods of no steering or ineffective collaborative steering. Other physical actions may include brake detection and measuring the time required by the operator to react to a system initiated request, delays in counter steering, and detectable non-driving related tasks, such as tuning a radio, utilizing voice commands, or interacting with an instrument cluster. Other features of a DMS and/or OMS may be used to observe physical actions which impact the collaboration scores. The collaboration information may be included with the ODD information and/or obtained from a server, such as the network resource 1128, and the mobile device 600 may be configured to associate the collaboration information with the ODDs along different routes to the desired destination.

The collaboration information for different possible routes to the destination may be compared and sorted such that routes with relatively higher collaboration scores may be given a preference over routes with lower collaboration scores. For example, two potential routes may include two different sections of divided highway driving ODDs associated with HFO, LKA and SKA ADAS functions. The collaboration information for each of the two potential routes may vary based on other factors which are not explicitly defined for the ODD. For example, a first route may traverse an area with a heavy concentration of retail stores and/or roadside dining locations which includes signage and pedestrian traffic which may distract operators driving through the area (e.g., the first route has a relatively low collaboration score do to the impact of the distractions). Conversely, a second route may traverse a more austere industrial park with relatively little signage or pedestrian traffic to distract a driver (e.g., the second route has a relatively higher collaboration score). The types and causes of potential distractions or other factors which may lower the collaboration scores for operators may vary greatly, but the general trends may be analyzed and scored based on the crowdsourced data. Thus, the routing applications may utilize the collaboration scores associated with ODD and/or locations to generate ADAS friendly routes which may improve the effective use of ADAS functions. The generated route information may be utilized by a navigation system to enable the operator to select a proposed route to the destination.

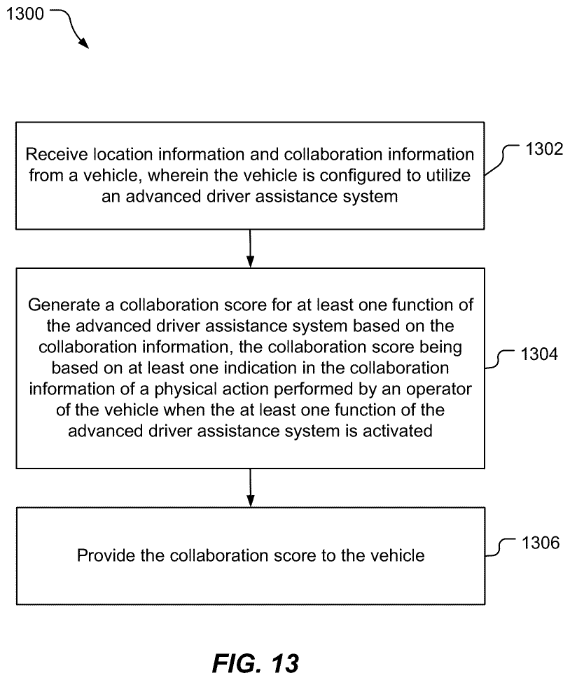

Referring to FIG. 13, with further reference to FIGS. 1-11, a method 1300 for providing a collaboration score associated with an ADAS to a vehicle includes the stages shown. The method 1300 is, however, an example and not limiting. The method 1300 may be altered, e.g., by having stages added, removed, rearranged, combined, performed concurrently, and/or having single stages split into multiple stages.

At stage 1302, the method includes receiving location information and collaboration information from a vehicle, wherein the vehicle is configured to utilize an advanced driver assistance system. A server 400, such as the network resource 1128, the LMF 120 and the external client 130, including a processor 410 and a transceiver 415, is a means for receiving the location information and collaboration information. In an example, referring to the process 1100, a mobile device 600 may be configured to provide collaboration information such as collaboration scores established at stage 1112 for different ADAS functions to a network server, such as the network resource 1128. The collaboration information may include operator responses determined at stage 1118 as well as an indication of the ADAS functions and ODDs associated with the collaboration score. The location information may be based on the location associated with the collaboration score as obtained by terrestrial and/or satellite positioning methods. The location information and collaboration information may be received via V2X communications as described in FIG. 5. Other communication methods may also be used.

At stage 1304, the method includes generating a collaboration score for at least one function of the advanced driver assistance system based on the collaboration information, the collaboration score being based on at least one indication in the collaboration information of a physical action performed by an operator of the vehicle when the at least one function of the advanced driver assistance system is activated. The server 400, including the processor 410, is a means for generating a collaboration score. The collaboration scores may be normalized values to compare different operator actions on a relative scale. For example, a distraction time may be based on indications in the collaboration information such as durations of eye gazes away from the road, head posture indications may be scored based on the position and/or rapidity of movement (e.g., head-bobs), reaction times to alerts, time spent on operating center console devices (e.g., tuning a radio), the number of voice interactions, etc. may be compared for different operators and ranked on a linear scale. The collaboration information may include the indications of physical actions performed by the operator of the vehicle at a given location, and the collaboration score may be an indication of how the operator has performed based a larger data sample of physical actions (e.g., collaboration information) obtained from other vehicles for other operators at that location. Other scoring mechanisms may also be used to generate the collaboration scores based on relative collaboration activities of operators when ADAS functions are activated as included in the collaboration information.

At stage 1306, the method includes providing the collaboration score to the vehicle. The server 400, including the processor 410 and transceiver 415, is a means for providing the collaboration score. In an example, the server 400 may be a network resource 1128 which is configured to provide collaboration scores and location information to mobile devices in a network. For example, the server 400 may utilize network protocols such as LPP/NPP to provide the collaboration score. Other 5G and 6G signaling, such as RRC may also be used to provide collaboration scores to mobile devices in a network. V2X communication techniques as described in FIG. 5 may also be used to provide the collaboration scores to network resources and/or other vehicles. In an example, the server 400 may include an API configured to receive requests including location information (e.g., a current location, a desired destination, or other portions of a route), and provide collaboration scores based on the location information. Indications of the ADAS functions associated with the collaboration score(s) may also be provided to the mobile device. Other signaling and message formats may be used to provide the collaboration scores to the mobile device.

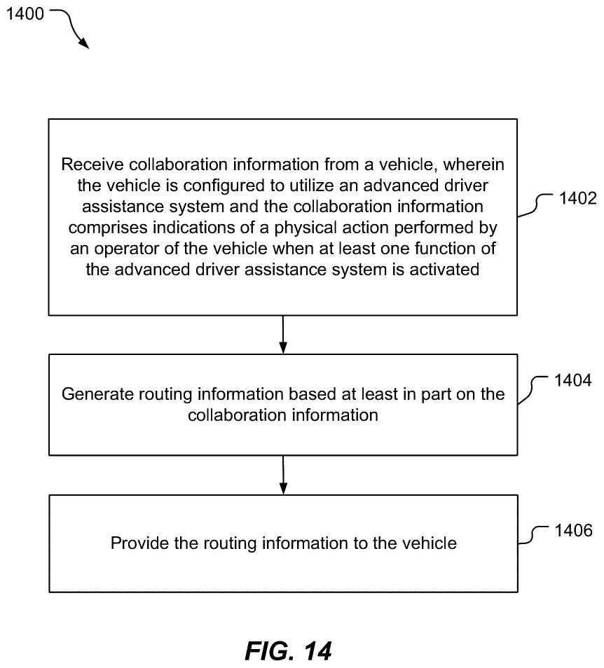

Referring to FIG. 14, with further reference to FIGS. 1-11, a method 1400 for providing routing information to a vehicle includes the stages shown. The method 1400 is, however, an example and not limiting. The method 1400 may be altered, e.g., by having stages added, removed, rearranged, combined, performed concurrently, and/or having single stages split into multiple stages.

At stage 1402, the method includes receiving collaboration information from a vehicle, wherein the vehicle is configured to utilize an advanced driver assistance system and the collaboration information comprises indications of a physical action performed by an operator of the vehicle when at least one function of the advanced driver assistance system is activated. A server 400, such as the network resource 1128, the LMF 120 and the external client 130, including a processor 410 and a transceiver 415, is a means for receiving the collaboration information. The collaboration information may be received via wireless signaling in the communication system 100, or other V2X technologies. The collaboration information may be indications associated with the performance of the operator while utilizing ADAS functions. In an example, physical actions performed by the operator may be the actions observed by operator monitoring sensors 662 or other sensors in a vehicle. The collaboration information may include time durations or counts associated with physical actions, such as the amount of time associated with eye gaze directions (e.g., eyes off road, long off-road glances, eye behavior associated with a confused state), or a number of times the operator takes their eyes off the road. Other collaboration information may be based on other observable actions such as head posture and other body motions which may be detected as an indication of distraction and/or drowsiness. The collaboration information may be the time required by a driver to react to a silent failure. The collaboration information may be obtained by steering wheel sensors and used to measure periods of no steering or ineffective collaborative steering. The collaboration information may be based on other physical actions, such as brake detection and measuring the time required by the operator to react to a system initiated request, delays in counter steering, and detectable non-driving related tasks, such as tuning a radio, utilizing voice commands, or interacting with an instrument cluster. Other features of a DMS and/or OMS may be used to observe physical actions which may be included in the collaboration information.

At stage 1404, the method includes generating routing information based at least in part on the collaboration information. The server 400 including a processor 410 is a means for generating routing information. The collaboration information for different possible routes may be compared and sorted such that routes with relatively higher collaboration scores may be given a preference over routes with lower collaboration scores. For example, two potential routes may include two different sections of divided highway driving ODDs associated with HFO, LKA and SKA ADAS functions. The collaboration information for each of the two potential routes may vary based on other factors which are not explicitly defined for the ODD. For example, a first route may traverse an area with a heavy concentration of retail stores and/or roadside dining locations which includes signage and pedestrian traffic which may distract operators driving through the area (e.g., the first route has relatively low collaboration do to the impact of the distractions). Conversely, a second route may traverse a more austere industrial park with relatively little signage or pedestrian traffic to distract a driver (e.g., the second route has relatively higher collaboration). The generated route information may be utilized by a navigation system to enable the operator to select a proposed route to the destination. Other factors may also be used to generate the routing information.

At stage 1406, the method includes providing the routing information to the vehicle. The server 400, including a processor 410 and a transceiver 415, is a means for providing the routing information to the vehicle. The communication system 100, or other V2X communication link, may be used to provide the routing information. In an example, the routing information may be map data including routing information. The map data may comply with the Navigation Data Standard (NDS), or other formats suitable for electronic transmission. The vehicle may include an OBU or other navigation system, the received route information may be utilized by such a navigation system to enable the operator to select a proposed route to a destination.

The method 1400 may be utilized for crowdsourcing implementations such that collaboration information from a plurality of vehicles may be received at stage 1402, and the routing information generated at stage 1404 may be based at least in part on the collaboration information associated with the plurality of vehicles. The routing information may be provided to other vehicles (e.g., vehicles that did not provide collaboration information at stage 1402) via the communication network 100, or using other data communications techniques (e.g., wired connections, satellite communications, etc.). Thus, routing information based on crowdsourced data may be provided to transient travelers in a geographic area.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for generating routing information for a vehicle configured with an advanced driver assistance system, comprising: obtaining a desired destination; obtaining operational design domain information based at least in part on a geographic area comprising a present location and the desired destination; and generating routing information based at least in part on collaboration information for one or more driving assistance functions associated with the operational design domain information, the collaboration information comprising indications of physical actions performed by vehicle operators when the one or more driving assistance functions are activated.

Clause 2. The method of clause 1, wherein the operational design domain information is included in map information received from a network resource.

Clause 3. The method of clause 1 or 2, wherein at least one of the indications of physical actions performed by vehicle operators is a duration of time for which an eye gaze of a vehicle operator is directed to an area other than a road the vehicle is traveling on.

Clause 4. The method of any of clauses 1 to 3, wherein at least one of the indications of physical actions performed by vehicle operators is a duration of time required by a vehicle operator to react to an alert generated by a vehicle safety system.

Clause 5. The method of any of clauses 1 to 4, wherein at least one of the indications of physical actions performed by vehicle operators is a duration of time required by a vehicle operator to react to a silent failure.

Clause 6. The method of any of clauses 1 to 5, wherein at least one of the indications of physical actions performed by vehicle operators is a duration of time a vehicle operator spends using a mobile device.

Clause 7. The method of any of clauses 1 to 6, wherein at least one of the indications of physical actions performed by vehicle operators is a head posture of a vehicle operator.

Clause 8. The method of any of clauses 1 to 7, wherein at least one of the indications of physical actions performed by vehicle operators is a level of interaction a vehicle operator performs with one or more vehicle systems.

Clause 9. The method of any of clauses 1 to 8, wherein the operational design domain information is based at least in part on a road classification for at least a portion of the geographic area.

Clause 10. The method of any of clauses 1 to 9, wherein the operational design domain information is based at least in part on a road design factors for at least a portion of the geographic area.

Clause 11. The method of any of clauses 1 to 10, wherein determining the collaboration information includes receiving the collaboration information from a network resource.

Clause 12. The method of clause 11, wherein the network resource is network server configured to communicate with a cellular network.

Clause 13. The method of any of clauses 1 to 12, wherein the one or more driving assistance functions include Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

Clause 14. The method of any of clauses 1 to 13, further comprising: obtaining physical action information for an operator of the vehicle with one or more operator monitoring sensors in the vehicle; and providing the physical action information, an indication of at least one driver assistance function, and location information to a network resource.

Clause 15. 1A method for providing a collaboration score associated with an advanced driver assistance system to a vehicle, the method comprising: receiving location information and collaboration information from the vehicle, wherein the vehicle is configured to utilize the advanced driver assistance system; generating the collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and providing the collaboration score to the vehicle.

Clause 16. The method of clause 15, wherein the at least one indication in the collaboration information of the physical action performed by the operator is a duration of time for which an eye gaze of the operator is directed to an area other than a road the vehicle is traveling on.

Clause 17. The method of clauses 15 or 16, wherein the at least one indication in the collaboration information of the physical action performed by the operator is a duration of time required by the operator to react to an alert generated by a driver assistance system operating in the vehicle.

Clause 18. The method of any of clauses 15 to 18, wherein the at least one indication in the collaboration information of the physical action performed by the operator is a head posture of the operator.

Clause 19. The method of any of clause 15 to 18, wherein the at least one indication in the collaboration information of the physical action performed by the operator is a level of interaction the operator performs with one or more systems in the vehicle.

Clause 20. The method of any of clause 15 to 19, wherein the at least one function of the advanced driver assistance system includes Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

Clause 21. The method of any of clauses 15 to 20, further comprising: receiving a request for the supplemental advanced driver assistance system constraint information from the mobile device; and providing one or more collaboration scores to the mobile device in response to receiving the request for the supplemental advanced driver assistance system constraint information.

Clause 22. The method of clause 21, wherein the request for the supplemental driver assistance system constraint information includes routing information including at least a current location and a desired destination.

Clause 23. The method of clause 22, further comprising providing location information and indications of one or more functions of the advanced driver assistance system associated with the one or more collaboration scores to the mobile device based on the routing information.

Clause 24. An example apparatus, comprising: at least one memory; at least one transceiver; at least one processor communicatively coupled to the at least one memory and the at least one transceiver, and configured to: determine a desired destination; obtain operational design domain information based at least in part on a geographic area including a present location and the desired destination; determine collaboration information for one or more driving assistance functions based on the operational design domain information, the collaboration information including indications of physical actions performed by vehicle operators when the one or more driving assistance functions are activated; and generating routing information based at least in part on the collaboration information.

Clause 25. The apparatus of clause 24, wherein the at least one processor is further configured to obtain map information including the operational design domain information.

Clause 26. The apparatus of clause 24 or 25, wherein at least one of the indications of physical actions performed by vehicle operators is a duration of time for which an eye gaze of a vehicle operator is directed to an area other than a road the vehicle is traveling on.

Clause 27. The apparatus of any of clauses 24 to 26, wherein at least one of the indications of physical actions performed by vehicle operators is a duration of time required by a vehicle operator to react to an alert generated by a vehicle safety system.

Clause 28. The apparatus of any of clauses 24 to 27, wherein at least one of the indications of physical actions performed by vehicle operators is a duration of time required by a vehicle operator to react to a silent failure.

Clause 29. The apparatus of any of clauses 24 to 28, wherein at least one of the indications of physical actions performed by vehicle operators is a duration of time a vehicle operator spends using a mobile device.

Clause 30. The apparatus of any of clauses 24 to 29, wherein at least one of the indications of physical actions performed by vehicle operators is a head posture of a vehicle operator.

Clause 31. The apparatus of any of clauses 24 to 30, wherein at least one of the indications of physical actions performed by vehicle operators is a level of interaction a vehicle operator performs with one or more vehicle systems.

Clause 32. The apparatus of any of clauses 24 to 31, wherein the operational design domain information is based at least in part on a road classification for at least a portion of the geographic area.

Clause 33. The apparatus of any of clauses 24 to 32, wherein the operational design domain information is based at least in part on a road design factors for at least a portion of the geographic area.

Clause 34. The apparatus of any of clauses 24 to 33, wherein the at least one processor is further configured to receive the collaboration information from a network resource.

Clause 35. The apparatus of clause 34, wherein the network resource is network server configured to communicate with a cellular network.

Clause 36. The apparatus of any of clauses 24 to 35, wherein the one or more driving assistance functions include Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

Clause 37. The apparatus of any of clauses 24 to 36, wherein the at least one processor is further configured to: obtain physical action information for an operator of a vehicle with one or more operator monitoring sensors in the vehicle; and provide the physical action information, an indication of at least one driver assistance function, and location information to a network resource.

Clause 38. An apparatus, comprising: at least one memory; at least one transceiver; at least one processor communicatively coupled to the at least one memory and the at least one transceiver, and configured to: receive location information and collaboration information from a vehicle utilizing an advanced driver assistance system; generate a collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and provide the collaboration score to the vehicle.

Clause 39. The apparatus of clause 38, wherein the at least one indication in the collaboration information of the physical action performed by the operator is a duration of time for which an eye gaze of the operator is directed to an area other than a road the vehicle is traveling on.

Clause 40. The apparatus of clause 38 or 39, wherein the at least one indication in the collaboration information of the physical action performed by the operator is a duration of time required by the operator to react to an alert generated by a driver assistance system operating in the vehicle.

Clause 41. The apparatus of any of clauses 38 to 40, wherein the at least one indication in the collaboration information of the physical action performed by the operator is a head posture of the operator.

Clause 42. The apparatus of any of clauses 38 to 41, wherein the at least one indication in the collaboration information of the physical action performed by the operator is a level of interaction the operator performs with one or more systems in the vehicle.

Clause 43. The apparatus of any of clauses 38 to 42, wherein the at least one function of the advanced driver assistance system includes Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

Clause 44. The apparatus of any of clauses 38 to 43, wherein the at least one processor is further configured to: receive a request for the supplemental advanced driver assistance system constraint information from the mobile device; and providing one or more collaboration scores to the mobile device in response to receiving the request for the supplemental advanced driver assistance system constraint information.

Clause 45. The apparatus of clause 44, wherein the request for the supplemental driver assistance system constraint information includes routing information including at least a current location and a desired destination.

Clause 46. The apparatus of clause 45, wherein the at least one processor is further configured to provide location information and indications of one or more functions of the advanced driver assistance system associated with the one or more collaboration scores to the mobile device based on the routing information.

Clause 47. An apparatus for generating routing information for a vehicle configured with an advanced driver assistance system, comprising: means for obtaining a desired destination; means for obtaining operational design domain information based at least in part on a geographic area comprising a present location and the desired destination; and generating routing information based at least in part on collaboration information for one or more driving assistance functions associated with the operational design domain information, the collaboration information comprising indications of physical actions performed by vehicle operators when the one or more driving assistance functions are activated.

Clause 48. An apparatus for providing a collaboration score associated with an advanced driver assistance system to a vehicle, comprising: means for receiving location information and collaboration information from the vehicle, wherein the vehicle is configured to utilize an advanced driver assistance system; means for generating a collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and means for providing the collaboration score to the mobile device.

Clause 49. A non-transitory processor-readable storage medium comprising processor-readable instructions configured to cause one or more processors to generate routing information for a vehicle configured with an advanced driver assistance system, comprising code for: obtaining a desired destination; obtaining operational design domain information based at least in part on a geographic area comprising a present location and the desired destination; and generating routing information based at least in part on collaboration information for one or more driving assistance functions associated with the operational design domain information, the collaboration information comprising indications of physical actions performed by vehicle operators when the one or more driving assistance functions are activated.

Clause 50. A non-transitory processor-readable storage medium comprising processor-readable instructions configured to cause one or more processors to provide a collaboration score associated with advanced driver assistance system to a vehicle, comprising code for: receiving location information and collaboration information from the vehicle, wherein the vehicle is configured to utilize an advanced driver assistance system; generating a collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and providing the collaboration score to the mobile device.

Clause 51. A method for providing routing information to a vehicle, comprising: receiving collaboration information from the vehicle, wherein the vehicle is configured to utilize an advanced driver assistance system and the collaboration information comprises indications of a physical action performed by an operator of the vehicle when at least one function of the advanced driver assistance system is activated; generating routing information based at least in part on the collaboration information; and providing the routing information to the vehicle.

Clause 52. An apparatus, comprising: at least one memory; at least one transceiver; at least one processor communicatively coupled to the at least one memory and the at least one transceiver, and configured to: receive collaboration information from the vehicle, wherein the vehicle is configured to utilize an advanced driver assistance system and the collaboration information comprises indications of a physical action performed by an operator of the vehicle when at least one function of the advanced driver assistance system is activated; generate routing information based at least in part on the collaboration information; and provide the routing information to the vehicle.

Clause 53. An apparatus for providing routing information to a vehicle, comprising: means for receiving collaboration information from the vehicle, wherein the vehicle is configured to utilize an advanced driver assistance system and the collaboration information comprises indications of a physical action performed by an operator of the vehicle when at least one function of the advanced driver assistance system is activated; means for generating routing information based at least in part on the collaboration information; and means for providing the routing information to the vehicle.

Clause 54. A non-transitory processor-readable storage medium comprising processor-readable instructions configured to cause one or more processors to provide routing information to a vehicle, comprising code for: receiving collaboration information from the vehicle, wherein the vehicle is configured to utilize an advanced driver assistance system and the collaboration information comprises indications of a physical action performed by an operator of the vehicle when at least one function of the advanced driver assistance system is activated; generating routing information based at least in part on the collaboration information; and providing the routing information to the vehicle.

1. A method for generating routing information for a vehicle configured with an advanced driver assistance system, the method comprising:
obtaining a desired destination;
obtaining operational design domain information based at least in part on a geographic area comprising a present location and the desired destination; and
generating routing information based at least in part on collaboration information for one or more driving assistance functions associated with the operational design domain information, the collaboration information comprising indications of physical actions performed by vehicle operators when the one or more driving assistance functions are activated.

2. The method of claim 1, wherein the operational design domain information is comprised in map information received from a network resource.

3. The method of claim 1, wherein at least one of the indications of physical actions performed by vehicle operators is a duration of time for which an eye gaze of a vehicle operator is directed to an area other than a road the vehicle is traveling on.

4. The method of claim 1, wherein at least one of the indications of physical actions performed by vehicle operators is a duration of time required by a vehicle operator to react to an alert generated by a vehicle safety system.

5. The method of claim 1, wherein at least one of the indications of physical actions performed by vehicle operators is a duration of time required by a vehicle operator to react to a silent failure.

6. The method of claim 1, wherein at least one of the indications of physical actions performed by vehicle operators is a duration of time a vehicle operator spends using a mobile device.

7. The method of claim 1, wherein at least one of the indications of physical actions performed by vehicle operators is a head posture of a vehicle operator.

8. The method of claim 1, wherein at least one of the indications of physical actions performed by vehicle operators is a level of interaction a vehicle operator performs with one or more vehicle systems.

9. The method of claim 1, wherein the operational design domain information is based at least in part on a road classification for at least a portion of the geographic area.

10. The method of claim 1, wherein the operational design domain information is based at least in part on a road design factors for at least a portion of the geographic area.

11. The method of claim 1, wherein generating the routing information comprises receiving the collaboration information from a network resource.

12. The method of claim 11, wherein the network resource is network server configured to communicate with a cellular network.

13. The method of claim 1, wherein the one or more driving assistance functions comprise Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

14. The method of claim 1, further comprising:
obtaining physical action information for an operator of the vehicle with one or more operator monitoring sensors in the vehicle; and
providing, to a network resource, the physical action information, an indication of at least one driver assistance function that is active at a time the physical action information is obtained, and location information at the time the physical action information is obtained.

15. A method for providing a collaboration score associated with an advanced driver assistance system to a vehicle, the method comprising:
receiving location information and collaboration information from the vehicle, wherein the vehicle is configured to utilize the advanced driver assistance system;
generating the collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and
providing the collaboration score to the vehicle.

16. The method of claim 15, wherein the at least one indication in the collaboration information of the physical action performed by the operator is a duration of time for which an eye gaze of the operator is directed to an area other than a road the vehicle is traveling on.

17. The method of claim 15, wherein the at least one indication in the collaboration information of the physical action performed by the operator is a duration of time required by the operator to react to an alert generated by a driver assistance system operating in the vehicle.

18. The method of claim 15, wherein the at least one indication in the collaboration information of the physical action performed by the operator is a head posture of the operator.

19. The method of claim 15, wherein the at least one indication in the collaboration information of the physical action performed by the operator is a level of interaction the operator performs with one or more systems in the vehicle.

20. The method of claim 15, wherein the at least one function of the advanced driver assistance system comprises Keep distance (KD), Speed Keep Assist (SKA), Lane Keep Assist (LKA), Stop at stop sign (SaSS), Stop and go at traffic light (SGTL), Adapt speed and trajectory to road geometry (ASTRG), Lane Change Assist (LCA), Change lane (CL), Hands-free driving option (HFO), Give right of way (GROW), Stop and give right of way (SGROW), Emergency change lane (ECL), Keep lane (KL), and Keep speed (KS), or combinations thereof.

21. The method of claim 15, further comprising:
receiving a request for supplemental advanced driver assistance system constraint information from the vehicle; and
providing the supplemental advanced driver assistance system constraint information to the vehicle.

22. The method of claim 21, wherein the request for the supplemental advanced driver assistance system constraint information comprises routing information comprising at least a current location and a desired destination.

23. The method of claim 22, further comprising providing location information and indications of one or more functions of the advanced driver assistance system and associated collaboration scores to the vehicle based on the routing information.

24. An apparatus, comprising:
at least one memory;
at least one transceiver;
at least one processor communicatively coupled to the at least one memory and the at least one transceiver, and configured to:
obtain a desired destination;
obtain operational design domain information based at least in part on a geographic area comprising a present location and the desired destination; and
generate routing information based at least in part on collaboration information for one or more driving assistance functions associated with the operational design domain information, the collaboration information comprising indications of physical actions performed by vehicle operators when the one or more driving assistance functions are activated.

25. The apparatus of claim 24, wherein the at least one processor is further configured to obtain map information comprising the operational design domain information.

26. The apparatus of claim 24, wherein the at least one processor is further configured to receive the collaboration information from a network resource.

27. The apparatus of claim 24, wherein the at least one processor is further configured to:
obtain physical action information for an operator of the vehicle with one or more operator monitoring sensors in the vehicle; and
provide the physical action information, an indication of at least one driver assistance function, and location information to a network resource.

28. An apparatus, comprising:
at least one memory;
at least one transceiver;
at least one processor communicatively coupled to the at least one memory and the at least one transceiver, and configured to:
receive location information and collaboration information from a vehicle configured to utilize an advanced driver assistance system;
generate a collaboration score for at least one function of the advanced driver assistance system based on the collaboration information, the collaboration score being based on at least one indication in the collaboration information of a physical action performed by an operator of the vehicle when the at least one function of the advanced driver assistance system is activated; and
provide the collaboration score to the vehicle.

29. The apparatus of claim 28, wherein the at least one processor is further configured to:
receive a request for supplemental advanced driver assistance system constraint information from the vehicle; and
provide the supplemental advanced driver assistance system constraint information to the vehicle.

30. The apparatus of claim 29, wherein the request for supplemental driver assistance system constraint information comprises routing information comprising at least a current location and a desired destination, and the at least one processor is further configured to provide indications of one or more functions of the advanced driver assistance system and associated collaboration scores to the vehicle based on the routing information.
